(19) United States
(12) Patent Application Publication
(10) Pub. No.: US 2012/0131460 A1
(43) Pub. Date: May 24, 2012

(54) Playlist Creation

(75) Inventor: Matthew John Toby COYLE-GILCHRIST, Shelfanger (GB)

(73) Assignee: Nokia Corporation

(21) Appl. No.: 13/286,531

(22) Filed: Nov. 1, 2011

(30) Foreign Application Priority Data
Nov. 19, 2010 (GB) 1019549.3

(51) Int. Cl. G06F 3/048

(52) U.S. Cl. 715/716

(57) ABSTRACT

A method, apparatus, and computer program product for: defining a graph of interconnected nodes, each node representing a content item; presenting the graph to a user; receiving a first user input defining a first route through one or more nodes via the interconnections, the route beginning at a first initial node and ending at a first terminal node; and determining a playlist comprising the content item associated with each node in the first route, ordered according to its node's position in the first route.

### TECHNICAL FIELD

The present application relates generally to a method, apparatus, and computer program product for defining a playlist.

### BACKGROUND

Ever increasing amounts of music, video, and other content is being stored on computing devices or other apparatus, or made accessible to them. Some users wish to order such content into playlists. A playlist may be, for example, an ordered list defining the order in which items of content may be presented to the user, or otherwise processed.

### SUMMARY

In a first aspect, there is provided a method comprising: defining a graph of interconnected nodes, each node representing a content item; presenting the graph to a user; receiving a first user input defining a first route through one or more nodes via the interconnections, the route beginning at a first initial node and ending at a first terminal node; and determining a playlist comprising the content item associated with each n ode in the first route, ordered according to its node's position in the first route.

In a second aspect, there is provided apparatus comprising: a processor; and memory including computer program code, the memory and the computer program code configured to, working with the processor, cause the apparatus to perform at least the following: define a graph of interconnected nodes, each node representing a content item; present the graph to a user; receive a first user input defining a first route through one or more nodes via the interconnections, the route beginning at a first initial node and ending at a first terminal node; and determine a playlist comprising the content item associated with each node in the first route, ordered according to its node's position in the first route.

In a third aspect, there is provided a computer program product comprising a computer-readable medium bearing computer program code em bodied therein for use with a computer, the computer program code comprising: code for defining a graph of interconnected nodes, each node representing a content item; code for presenting the graph to a user; code for receiving a first user input defining a first route through one or more nodes via the interconnections, the route beginning at a first initial node and ending at a first terminal node; and code for determining a playlist comprising the content item associated with each node in the first route, ordered according to its node's position in the first route.

In a fourth aspect, there is provided apparatus comprising: means for defining a graph of interconnected nodes, each node representing a content item; means for presenting the graph to a user; means for receiving a first user input defining a first route through one or more nodes via the interconnections, the route beginning at a first initial node and ending at a first terminal node; and means for determining a playlist comprising the content item associated with each node in the first route, ordered according to its node's position in the first route.

### BRIEF DESCRIPTION OF THE DRAWINGS

For a more complete understanding of example embodiments of the present invention, reference is now made to the following descriptions taken in connection with the accompanying drawings in which:

FIG. 1 is an illustration of an apparatus;

FIG. 2 is an illustration of a device;

FIG. 3 is an illustration of a graph;

FIG. 4 is an illustration of a portion of a graph;

FIG. 5 is an illustration of a graph;

FIG. 6 is an illustration of a graph;

FIG. 7 is an illustration of a graph;

FIG. 8 is an illustration of a graph;

FIGS. 9a and 9b are is an illustrations of a graph;

FIGS. 10a and 10b are is an illustrations of a graph;

FIGS. 11a and 11b are is an illustrations of a graph; and

FIG. 12 is a flow chart illustrating a method.

### DETAILED DESCRIPTION OF THE DRAWINGS

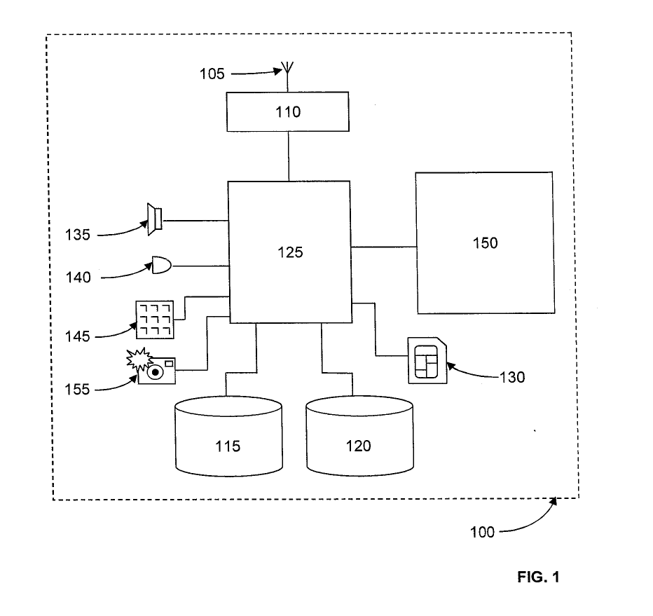

An example embodiment of the present invention and its potential advantages are understood by referring to FIGS. 1 through 12 of the drawings.

FIG. 1 illustrates an apparatus 100 according to an example embodiment of the invention. The apparatus 100 may comprise at least one antenna 105 that may be communicatively coupled to a transmitter and/or receiver component 110. The apparatus 100 may also comprise a volatile memory 115, such as volatile Random Access Memory (RAM) that may include a cache area for the temporary storage of data. The apparatus 100 may also comprise other memory, for example, non-volatile memory 120, which may be embedded and/or be removable. The non-volatile memory 120 may comprise an EEPROM, flash memory, or the like. The memories may store any of a number of pieces of information, and data—for example an operating system for controlling the device, application programs that can be run on the operating system, and user and/or system data. The apparatus may comprise a processor 125 that can use the stored information and data to implement one or more functions of the apparatus 100, such as the functions described hereinafter. In some example embodiments, the processor 125 and at least one of volatile 115 or non-volatile 120 memories may be present in the form of an Application Specific Integrated Circuit (ASIC), a Field Programmable Gate Array (FPGA), or any other application-specific component. Although the term “processor” is used in the singular, it may refer either to a singlular processor (e.g. an FPGA or a single CPU), or an arrangement of more than one singular processor that cooperate to provide an overall processing function (e.g. two or more FPGAs or CPUs that operate in a parallel processing arrangement).

The apparatus 100 may comprise one or more User Identity Modules (UIMs) 130. Each UIM 130 may comprise a memory device having a built-in processor. Each UIM 130 may comprise, for example, a subscriber identity module, a universal integrated circuit card, a universal subscriber identity module, a removable user identity module, and/or the like. Each UIM 130 may store information elements related to a subscriber, an operator, a user account, and/or the like. For example, a UIM 130 may store subscriber information, message information, contact information, security information, program information, and/or the like.

The apparatus 100 may comprise a number of user interface components. For example, a microphone 135 and an audio output device such as a speaker 140. The apparatus 100 may comprise one or more hardware controls, for example a plurality of keys laid out in a keypad 145. Such a keypad 145 may comprise numeric (for example, 0-9) keys, symbol keys (for example, #, *), alphabetic keys, and/or the like for operating the apparatus 100. For example, the keypad 145 may comprise a conventional QWERTY (or local equivalent) keypad arrangement. The keypad may instead comprise a different layout, such as E.161 standard mapping recommended by the Telecommunication Standardization Sector (ITU-T). The keypad 145 may also comprise one or more soft keys with associated functions that may change depending on the input of the device. In addition, or alternatively, the apparatus 100 may comprise an interface device such as a joystick, trackball, or other user input component.

The apparatus 100 may comprise one or more display devices such as a screen 150. The screen 150 may be a touchscreen, in which case it may be configured to receive input from a single point of contact, multiple points of contact, and/or the like. In such an example embodiment, the touchscreen may determine input based on position, motion, speed, contact area, and/or the like. Suitable touchscreens may involve those that employ resistive, capacitive, infrared, strain gauge, surface wave, optical imaging, dispersive signal technology, acoustic pulse recognition or other techniques, and to then provide signals indicative of the location and other parameters associated with the touch. A “touch” input may comprise any input that is detected by a touchscreen including touch events that involve actual physical contact and touch events that do not involve physical contact but that are otherwise detected by the touchscreen, such as a result of the proximity of the selection object to the touchscreen. The touchscreen may be controlled by the processor 125 to implement an on-screen keyboard.

In other examples, displays of other types may be used. For example, a projector may be used to project a display onto a surface such as a wall. In some further examples, the user may interact with the projected display, for example by touching projected user interface elements. Various technologies exist for implementing such an arrangement, for example by analysing video of the user interacting with the display in order to identify touches and related user inputs.

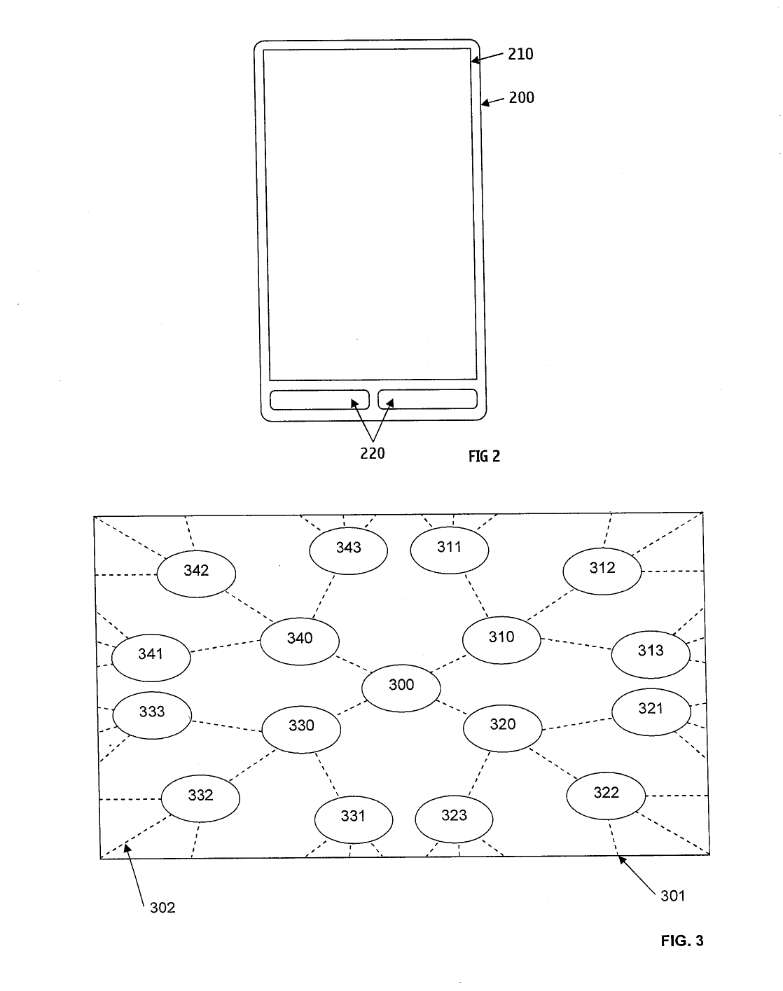

FIG. 2 illustrates a computing device 200 that is an example of the apparatus 100 of FIG. 1. The device has a touch screen 210 and hardware buttons 220, although different hardware features may be present. For example, instead of a touchscreen 210 the device 200 may have a non-touch display upon which a cursor can be presented, the cursor being movable by the user according to inputs received from the hardware buttons 220, a trackball, a mouse, or any other suitable user interface component.

Non-exhaustive examples of the apparatus 100 may include a mobile telephone or other mobile communication device, a personal digital assistant, a laptop computer, a tablet computer, a games console, a personal media player, an Internet terminal, a jukebox, or any other computing device. Suitable apparatus may have all, some, or none of the features described above.

FIG. 3 illustrates a presentation of a graph 301 of interconnected nodes. The presentation may be, for example, a visual representation on a display—for example the display 150 of apparatus 100. Other examples of presentations may be used—for example the presentation may be an audio presentation or a haptic presentation. Whilst any form of presentation through which the nodes and their interconnections may be presented to the user may be used, the following examples will use the example of a visually represented presentation—this is not intended to limit the scope of the disclosure.

Each of the nodes (300, 310, 311, etc.) in the graph 301 represents an item of content. The item of content may be an item of media content, for example a music track or other sound file, a video, or an image. The item of content may instead be another type of document, for example a word processing file or spreadsheet. The item of content may instead be any other type of content, for example a contact in a phonebook, or any other data item.

The content items in the graph are interconnected by links (e.g. link 302). A link between two content items is a representation that the two content items have a particular relationship. For example, the link may represent that the two items have at least a minimum similarity based on some measure of similarity. For example, if the items are music tracks the measure of similarity may be that the music tracks have similar tempos, musical styles, release dates, frequency spectra, and/or other criteria. Any suitable measurable or pre-defined criteria may be used, including subjective criteria defined from one or more users. The measure of similarity may be based on a subjective analysis, for examples opinions that have been expressed by one or more users, or the presence of the items together in libraries maintained or purchased by users. The similarity may be based on a single criterion or a combination of multiple criteria, for example a combination in which each criterion is weighted by a perceived relevance or importance to the similarity. The choice of criteria and the choice of algorithm for combining multiple criteria will depend on the nature of the content items and on the purpose for which the graph 301 is generated and it will be understood that any suitable choices may be used.

The presence of a link may not be solely dependent upon the similarity between two content items. For example, a limit may be imposed on the total number of links that can be made to each node, one possible effect of this being that the complexity of the graph can be reduced by reducing the maximum number of links. In some examples, the maximum number of links may depend on the number of modes presented to user, with a greater number of links permitted when fewer nodes are presented. Where a maximum number of links is imposed, the presented links may be determined based, for example, on the strength of the similarity represented by the links. For example, when a maximum number N of links is imposed, only links to a maximum of the N most similar other nodes may be presented. The maximum number of links may be pre-defined by a manufacturer, defined by the user, or may be varied dynamically depending upon the number of nodes presently displayed in the graph (e.g. a graph showing many nodes may be dynamically simplified for the user by reducing the number of links).

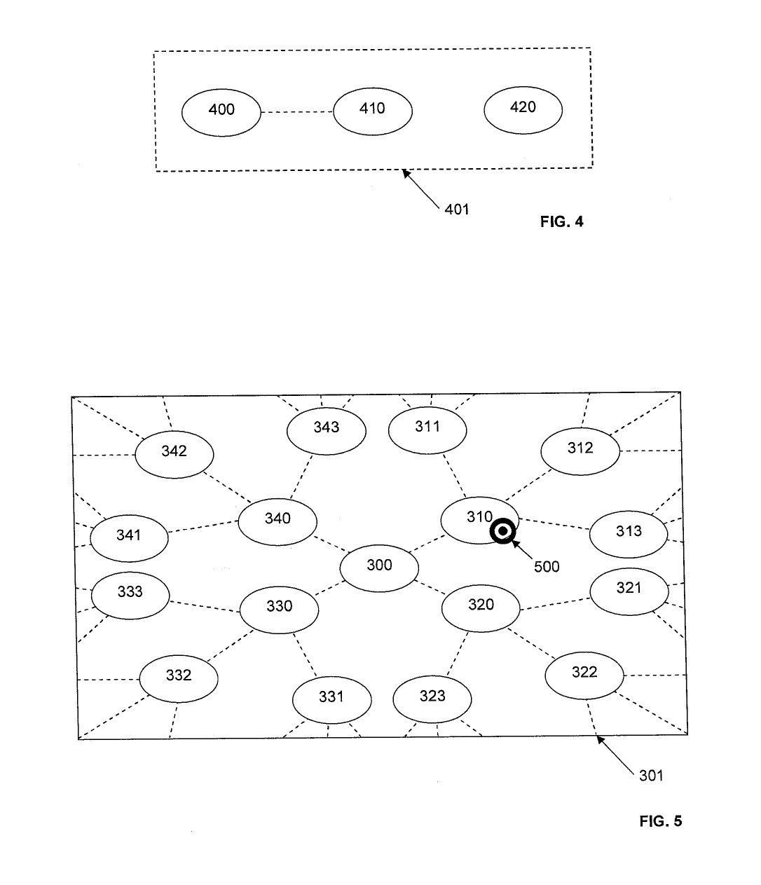

The presence of a link may depend on criteria other than a direct comparison between the linked nodes. For example FIG. 4 illustrates an example of a graph 401 comprising three nodes 400, 410, 420. A link already exists between nodes 400 and 410, for the reason that the content items that these nodes represent have a similarity greater than the minimum similarity required for a link to be established. In this example there exists an additional criterion that a link can only be established between two nodes if the two nodes have a similarity greater than a minimum similarity and the similarity between one of the nodes and the nodes already linked to the other of the nodes is less than a maximum similarity. In the example of FIG. 4, the similarity between nodes 420 and 400 is greater than this maximum similarity, and node 420 will therefore not be linked to node 410. It may be, however, that a link could be established directly between nodes 400 and 420.

An effect of this requirement on the second order similarity of the nodes is that the content items will diversify through the graph. Accordingly, as successive links are followed away from an initial node, the content items represented by adjacent nodes will be similar to one another, but the content items may become increasingly dissimilar from the item associated with the initial node the further from it the links are followed. An effect of this may be that a path through the graph provides a slowly diversifying sequence of content items—a quality that may be desirable in e.g. a playlist that is to encompass a diverse range of content without noticeably sudden transitions across that range.

If a link had already been established between only nodes 410 and 420 of FIG. 4, the similarity between these nodes may prevent a link from being established between nodes 400 and 410. This would result in a different graph to the graph 401 illustrated in FIG. 4. Essentially, it would be possible to link nodes 400 and 410, or 410 and 420, but not possible for both links to exist simultaneously. Such conflicts may be resolved by maintaining the earliest formed link, the link representing the strongest similarity, or by implementing any other suitable technique for avoiding conflicts. An example of another suitable technique may be to count the number of existing links present at each node and create the link to the node with the fewest number of existing links (for example, if node 400 already had 6 links and node 420 only had one link, then the link between nodes 410 and 420 would be created in preference to the link between 400 and 410).

In some examples, the structure of the graph will result from the order in which nodes are added to it. In such cases, a user may specify an order in which content items (represented by their nodes) are added to the graph. In some examples, the user may specify a single content item as a starting point for the graph, in response to which a single node (hereinafter referred to as a “root node”) is added to the graph and all subsequent nodes are added based on their relationship with either the root node or another node already added to the graph. In such cases, the root node may be of particular interest to the user and the presentation of the graph may be centred on the root node (for example, the presentation of the graph 301 shown in FIG. 3 is centred on node 300, which appears in the most prominent position in the presentation—the centre). In other examples, the user may select a subset of multiple content items from a larger set of content items that are available to added to the graph, those items in the subset being prioritised over the items not in the subset when the graph is created (e.g. by creating links to nodes representing these items before creating links to other nodes).

In some embodiments, more than one node may represent the same content item, allowing the content item to be represented by nodes at more than one position in the graph. However, in other embodiments, each content item may be represented by a maximum of one node.

It is not necessarily the case that all nodes in the graph are presented to the user, or that all links between nodes are displayed to the user. For example, only a maximum number of links to any given node may be presented, and nodes having fewer than a threshold number of links (or displayed links) may not be presented. For example, in the graph 301 illustrated in FIG. 3, only the four links to any node that represent the strongest similarities to that node are displayed, and no nodes having less than four links are displayed.

Returning to FIG. 3, the graph 301 extends beyond its visible boundaries (i.e. its representation on a display). The presentation of the graph 301 may therefore be modified so that a different portion of the graph 301 is presented, or so that the entire graph 301 is presented. In some examples, this modification of the presentation may be performed by zooming and/or scrolling the presentation of the graph. For example, where the graph 301 is presented on a touch screen, the user may touch and drag the presentation to the left in order to view nodes and links to the right of nodes 312, 313, 321, and 322. Other suitable techniques for scrolling the graph may be used instead or in addition to a touch drag: for example, the use of a joystick or mouse, voice commands, or eye-tracking.

FIG. 5 illustrates the graph 301 of FIG. 3, where a user has performed a user input identifying a location associated with a node on the graph. Many possible user inputs may be possible, but the illustrated action is that of a touch 500 on a touchscreen at a location corresponding to node 310. Other suitable user inputs include, but are not limited to, single point inputs such as a mouse click or button press when a cursor is at a particular location. Single point inputs are inputs that define a single point location (e.g. the location of node 310) rather than a larger area or path.

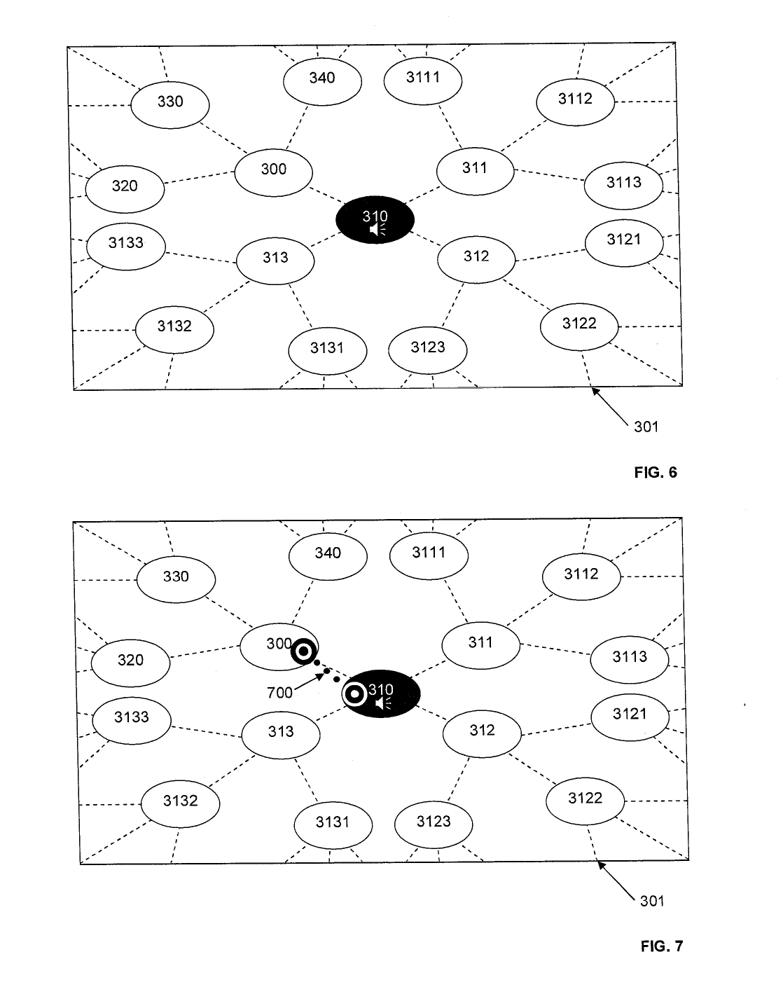

FIG. 6 illustrates the presentation of the graph 301 of FIGS. 3 and 5, updated in response to the user input 500. In response to the user input, the graph has been re-centred around node 310, node 310 has been highlighted, and the content item associated with node 310 (e.g. a music track) has started to play. It is not necessarily the case that all these actions are performed in response to the user input—other actions or different combinations of actions may be performed instead. For example, node 310 may be highlighted or otherwise differentiated from the other nodes without playing the content item associated with it.

In FIG. 6, the node associated with a content item that is currently playing (in this case, node 310) is distinguished from the other nodes in the presented graph 301. In the example of FIG. 6 the distinction is a visual distinction, in this example the presence of a loudspeaker icon within the representation of node 310; however, any other suitable visual or other distinction may be used. In some other examples, no distinction is made.

FIG. 7 illustrates the presentation of the graph 301 of FIG. 6, in relation to which a user has performed a user input identifying a subsequent node (node 300) on the graph 301. In the specific example shown in FIG. 7, this has been done by the user making a translation input 700 between node 310 (already selected) and node 300—for example a drag touch input starting at the representation of node 310 on a touchscreen and ending at the representation of node 300. Other types of translation input are possible, for example a click-drag using a mouse. Translation inputs are, generally, inputs that define a translation or path between two or more locations. In other embodiments, the user input may not be a translation input, but another type of input, for example a single point input identifying node 300, in some cases accompanied by a separate input or setting that identifies the purpose of the single point input.

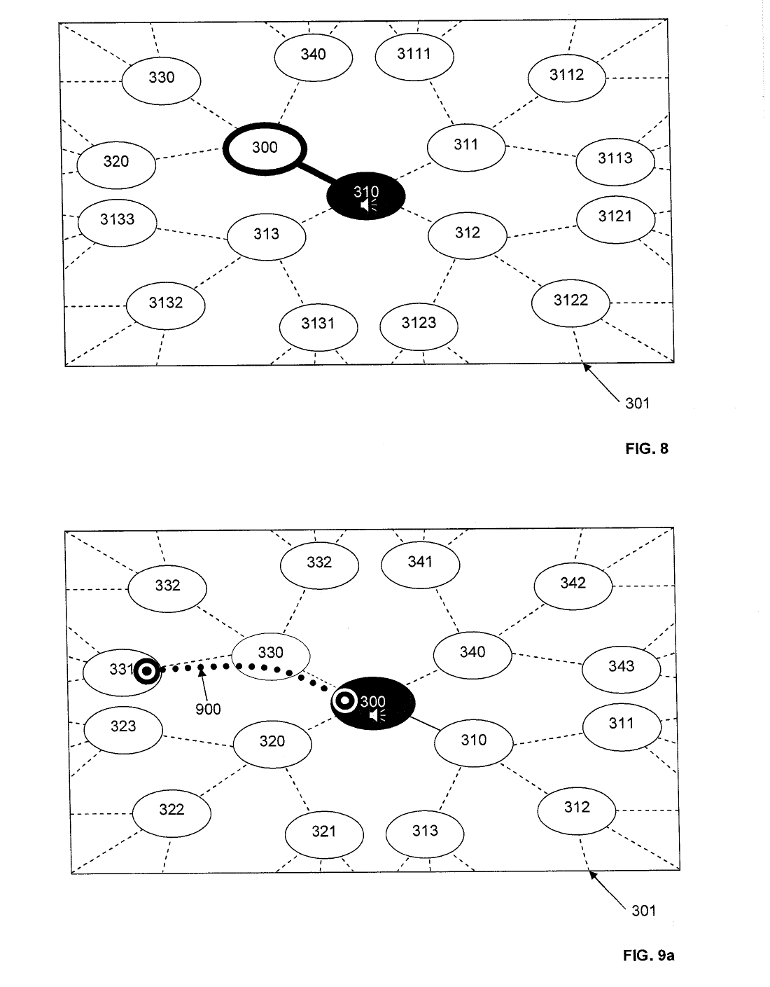

FIG. 8 illustrates the graph 301 of FIG. 7 updated in response to the user input 700 identifying node 300. In the illustration, nodes 310 and 300 and the link between them have been visually differentiated from the other nodes by highlighting, but in other examples the differentiation may be a different visual differentiation (e.g. animation), or a non-visual differentiation (e.g. using haptic feedback or audio). In still other examples, no differentiation may be present.

In some examples, an effect of the user inputs identifying nodes 310 and 300 is to create a route between these nodes through the links of the graph that begins at node 310 and ends at 300. The route may be constrained to connecting nodes only where a link is present between them. In the case of nodes 310 and 300, the nodes are directly interconnected by a single link. However, this is not necessarily the case. In some instances, identified nodes may not be directly connected and the graph 301 may be searched to find a possible route.

Sometimes it will be the case that more than one route is found to exist between identified nodes of a graph. In such a case, a route from amongst the possible routes route may be manually selected by the user, or automatically selected according to one or more heuristics. Suitable heuristics may include selecting the shortest route (i.e. the route that follows the shortest number of links), or the route that most closely matches the path of a translation input entered by the user (for example the input used to identify one or more of the identified nodes). In the latter case, the translation input may be accompanied by a visual representation of a potential route as a preview during the input, the potential route snapping to those interconnected nodes and links that are closest to the path of the translation input.

Since each node represents an item of content, actions can be performed upon the represented content items based on routes through the graph 301. Such actions may be performed in response to the creation or modification of a route. For example, a playlist of content items (e.g. audio or video clips, or images) may be created comprising content items represented by the nodes along a route. Alternatively the items of content may be moved or copied to a particular location, printed, shared, or otherwise subjected to any suitable operation. In the example of a playlist, the content items in the playlist may be ordered according to the order of the nodes in the route.

For example, the route shown in FIG. 8 may give rise to a playlist comprising just two content items—those associated with nodes 310 and 300. Since node 310 occurs first in the route, the playlist may be ordered so that the content item associated with node 310 is followed by the content item associated with node 300.

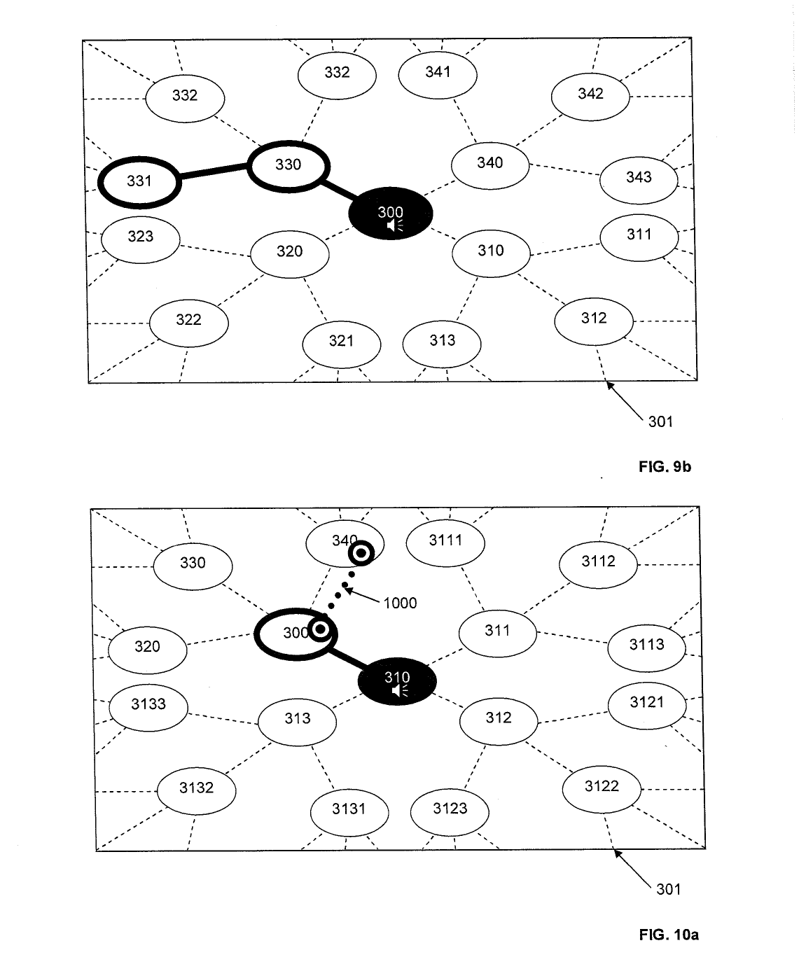

FIG. 9a shows the graph 301 of FIG. 3 in which the content item associated with node 300 has been initially selected for playback. FIG. 9 also shows that a translation input 900 has been made by the user between nodes 300 and 331. The path of the translation input is close to a valid route between these nodes formed by the links between nodes 300 and 330, and nodes 330 and 331. A route is therefore defined following nodes 300, 330, and 331 as shown in FIG. 9b. The route shown in FIG. 9b may be mapped to a three-item playlist starting with the content item associated with node 300, following with the content item associated with node 330, and finishing with the content item associated with node 331. Since the content item associated with node 300 is already playing, it may be immediately followed upon completion by the content item associated with node 330, and so on.

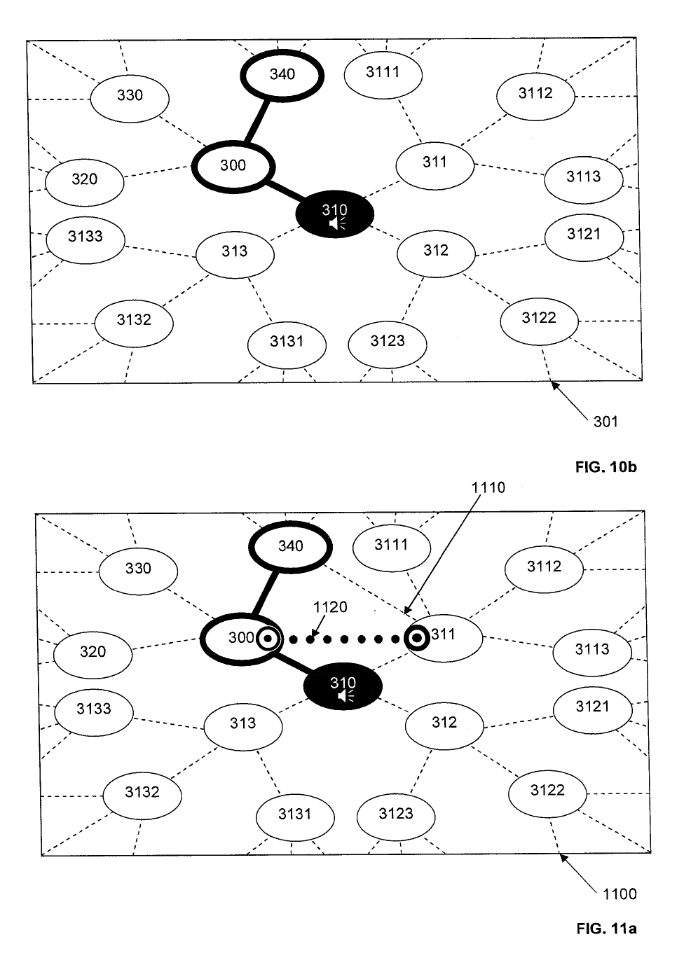

Starting from FIG. 8, FIG. 10a illustrates a further example in which a translation input has been received starting from node 300 and extending to node 340. At this point, node 300 is the terminal node of the route that has already been established in the graph (i.e. the two-node route between nodes 310 and 300) and the content item associated with node 300 may therefore reside at the end of a playlist associated with the route through the graph. In response to a translation input starting from the terminal node (in this case node 300), in some examples the route through the graph may be extended through the links of the graph. FIG. 10b shows the resulting extended route, which now includes the link from node 300 to node 340. The playlist may be correspondingly extended.

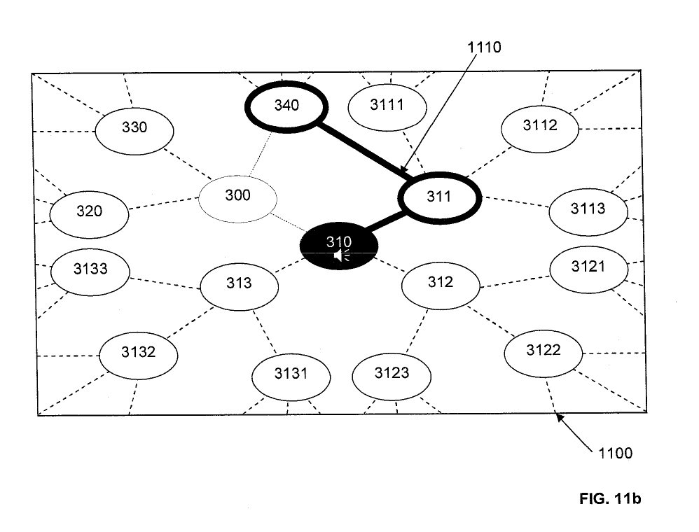

FIG. 11 shows a graph 1100 that is not unlike the graph of FIG. 10a. Note, however, that the graph happens to include an extra link 1110 connecting nodes 311 and 340. A route connecting nodes 310, 300 and 340 has already been established. In the example of FIG. 11, a translation input has been received starting at node 300 and ending at node 311. Since node 300 is not the terminal node of the route, in this exam pie such an input does not have the effect of appending one or more extra nodes to the end of the route. Instead, it represents an intended modification of the existing route starting from node 300. Node 311 is referred to as a “detour node”, since it represents a node through which the route is to be re-routed. The route, when re-routed through the detour node, is referred to as a “detour route”.

In the example of FIG. 11, the transition input is interpreted as a desire on the user's part to replace the current with a route between nodes 310 and 340 that passes through detour node 311. In graph 1100 such a route is possible and the detour route replaces the original route, as shown in FIG. 11b.

The graph 1100 of FIGS. 11a and 11b has been specially chosen so that exactly one possible detour route exists, for clarity of illustration. However, it is not always the case that only one potential detour route exists, or that any potential detour route exists at all.

In the case where more than one potential detour routes exists, heuristics may be employed to select a new route. In some examples the first potential detour route that the system finds (e.g. when searching the graph for potential detour routes) will be used, and the search for other possibilities cancelled. In some other examples, the potential detour route most similar to the original route will be selected (e.g. the potential detour route with the most nodes in common and the fewest additional nodes). Other suitable heuristics may be chosen instead.

Where no potential detour routes exist, in some examples no replacement will be made. Instead, the user may be notified that an error has occurred, for example using audio or visual feedback. In other examples, a new route beginning at the start of the original route and terminating at the end of the translation input will replace the original route as a detour route, despite the fact that such a route does not end with the same terminal node as the original route. Where more than one such new route exists, a selection may be made according to one or more suitable criteria (e.g. the first new route found, the shortest new route, or the new route most similar to the original route).

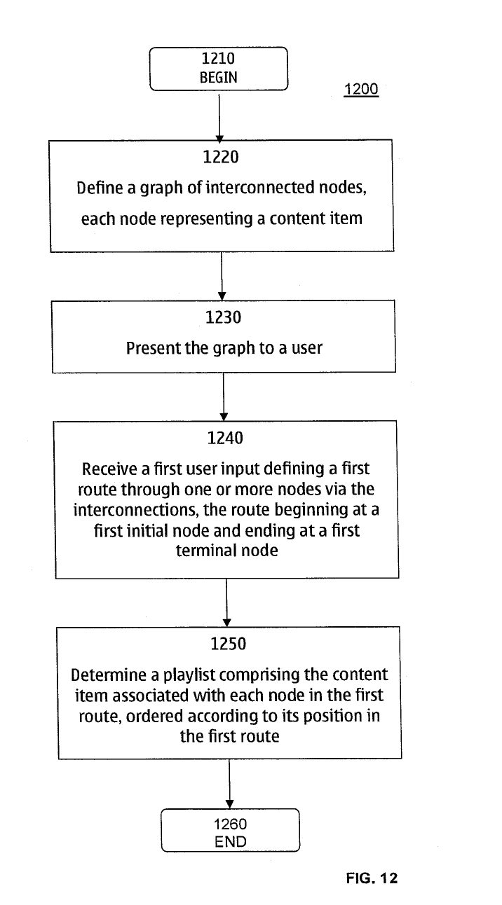

FIG. 12 illustrates an example method 1200 that may be used to provide functionality that has been described above. The method starts at step 1210. Thereafter, a graph of interconnected nodes is defined 1220, each node representing a content item. The graph is presented to a user 1230. A first user input is received 1240, defining a first route through one or more nodes via the interconnections, the route beginning at a first initial node and ending at a first terminal node. A playlist is then determined 1250, the playlist comprising the content item associated with each node in the first route, ordered according to its node's position in the first route. The method 1200 then ends 1260.

Without in any way limiting the scope, interpretation, or application of the claims appearing below, a technical effect of one or more of the example embodiments disclosed herein is that a playlist can easily compiled by a user, by means of which a diverse range of content items can be smoothly presented.

Example embodiments of the present invention may be implemented in software, hardware, application logic or a combination of software, hardware and application logic. The software, application logic and/or hardware may reside on a removable memory, within internal memory or on a communication server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of a computer described and depicted in FIG. 1. A computer-readable medium may comprise a computer-readable storage medium that may be any media or means that can contain or store the instructions for use by or in connection with an instruction execution system, apparatus, or device, such as a computer.

In some example embodiments, the invention may be implemented as an apparatus or device, for example a mobile communication device (e.g. a mobile telephone), a PDA, a computer or other computing device, or a video game console.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described example embodiments and/or the dependent claims with the features of the independent claims, and not solely the combinations explicitly set out i n the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method comprising:
defining a graph of interconnected nodes, each node representing a content item;
presenting the graph to a user;
receiving a first user input defining a first route through one or more nodes via interconnections, the route beginning at a first initial node and ending at a first terminal node; and
determining a playlist comprising a content item associated with each node in the first route, ordered according to the associated node's position in the first route.

2.-29. (canceled)

30. Apparatus comprising:
a processor; and
memory including computer program code, the memory and the computer program code configured to, working with the processor, cause the apparatus to perform at least the following:
define a graph of interconnected nodes, each node representing a content item;
present the graph to a user;
receive a first user input defining a first route through one or more nodes via interconnections, the route beginning at a first initial node and ending at a first terminal node; and
determine a playlist comprising a content item associated with each node in the first route, ordered according to the associated node's position in the first route.

31. Apparatus according to claim 30, wherein defining the graph comprises:
determining whether a predetermined relationship exists between a first content item and a second content item; and
interconnecting first and second nodes representing the first and second content items in the graph only if the predetermined relationship exists.

32. Apparatus according to claim 31, wherein the predetermined relationship comprises a minimum similarity between the first and second content items.

33. Apparatus according to claim 32, wherein:
the second node is already interconnected with a third node representing a third content item, the predetermined relationship further comprises a maximum similarity between the first and third content items.

34. Apparatus according to any of claims 30 to 33 claim 30, wherein defining the graph comprises:
receiving user selection of a seed content item; and
adding a node representing the seed content item to the graph as a root node.

35. Apparatus according to claim 34, wherein the memory and the computer program code are further configured to, working with the processor, cause the apparatus to perform at least the following:
centre the presentation of the graph on the root node.

36. Apparatus according to claim 35, wherein any content item is represented by a maximum of one node in the graph.

37. Apparatus according to claim 30, wherein the memory and the computer program code are further configured to, working with the processor, cause the apparatus to perform at least the following:
present the first route to the user with the graph.

38. Apparatus according to claim 30, wherein in response to the reception of the first user input, the presentation of the graph is re-centred on the first terminal node.

39. Apparatus according to claim 30, wherein the first user input is a translation input between locations corresponding to the first initial node and the first terminal node.

40. Apparatus according to claim 30, wherein the memory and the computer program code are further configured to, working with the processor, cause the apparatus to perform at least the following:
receive a second user input defining a second route through one or more nodes via the interconnections, the second route beginning at a second initial node and ending at a second terminal node; and
in response to receiving the second user input, determine a second playlist comprising the content items associated with each node in the second route, ordered according to its node's position in the second route.

41. Apparatus according to claim 40, wherein the memory and the computer program code are further configured to, working with the processor, cause the apparatus to perform at least the following:
re-centre the presentation of the graph on the second terminal node and present the second route to the user with the graph.

42.-44. (canceled)

45. Apparatus according to claim 40, wherein the memory and the computer program code are configured to, working with the processor, cause the apparatus to perform at least the following:
receive a third user input defining a third route through one or more nodes via the interconnections, the third route beginning at the first terminal node and ending at a third terminal node; and
in response to receiving the third user input:
append the third route to the first route, and
determine a third playlist comprising the content items associated with each node in the appended routes, ordered according to its node's position in the appended routes.

46. Apparatus according to claim 45, wherein the memory and the computer program code are further configured to, working with the processor, cause the apparatus to perform at least the following:
re-centre the presentation of the graph on the third terminal node and present the appended routes to the user with the graph.

47. (canceled)

48. Apparatus according to claim 45, wherein the third user input is a translation input between locations corresponding to the first terminal node and the third terminal mode.

49. Apparatus according to claim 45, wherein the memory and the computer program code are further configured to, working with the processor, cause the apparatus to perform at least the following:
receive a fourth user input defining a fourth route through one or more nodes via the interconnections, the fourth route beginning at a fourth initial node and ending at a fourth terminal node, wherein the fourth initial node is a node on the first route; and
in response to receiving the fourth user input:
append the first route between the first initial node and the fourth initial node to the fourth route, and
determine a fourth playlist comprising the content items associated with each node in the appended routes, ordered according to its node's position in the appended routes.

50. Apparatus according to claim 49, wherein the memory and the computer program code are further configured to, working with the processor, cause the apparatus to perform at least the following:
re-centre the presentation of the graph on the fourth terminal node and present the appended routes to the user with the graph, and where the fourth user input is a translation input between locations corresponding to the fourth initial node and the fourth terminal mode.

51.-52. (canceled)

53. Apparatus according to claim 49, wherein the memory and the computer program code are further configured to, working with the processor, cause the apparatus to perform at least the following:
receive a fifth user defining a detour node not being in the first route;
in response to receiving the fifth user input:
search the graph to determine whether one or more detour routes are possible through the interconnections between the first initial node and the first terminal node via the detour node, and
if at least one detour route is possible, select a detour route from amongst the possible detour routes and determining a fifth playlist comprising the content items associated with each node in the selected detour route, ordered according to its node's position in the selected detour route,
where if no possible detour route is found between the first initial node and the first terminal node via the detour node:
further search the graph to determine whether one or more detour routes are possible through the interconnections between the first initial node and the detour node, and
if at least one detour route is possible, select a detour route from amongst the possible detour routes and determining a fifth playlist comprising the content items associated with each node in the selected detour route, ordered according to its node's position in the selected detour route;
wherein the memory and the computer program code are further configured to, working with the processor, cause the apparatus to at least re-centre the presentation of the graph on the detour node and present the selected detour route to the user with the graph;
where the detour route is selected based on its similarity to the first route.

54.-60. (canceled)

61. A computer program product comprising a computer-readable medium bearing computer program code embodied therein for use with a computer, the computer program code comprising:
code for defining a graph of interconnected nodes, each node representing a content item;
code for presenting the graph to a user;
code for receiving a first user input defining a first route through one or more nodes via interconnections, the route beginning at a first initial node and ending at a first terminal node; and
code for determining a playlist comprising a content item associated with each node in the first route, ordered according to the associated node's position in the first route.

62.-90. (canceled)
